(19) United States
(12) Patent Application Publication
(10) Pub. No.: US 2016/0182425 A1
(43) Pub. Date: Jun. 23, 2016

(54) METHOD AND SYSTEM FOR FACILITATING COMMUNICATION BASED ON GEOLOCATION

(71) Applicant: Lohalo, LLC, Cumming, GA (US)

(72) Inventor: Mirza Amin Asghar, Cumming, GA (US)

(21) Appl. No.: 14/972,387

(22) Filed: Dec. 17, 2015

Related U.S. Application Data
(60) Provisional application No. 62/094,189, filed on Dec. 19, 2014.

(51) Int. Cl. H04L 12/58; H04W 4/14; H04L 29/08

(52) U.S. Cl. CPC H04L 51/20; H04L 67/18; H04L 51/36; H04L 51/38; H04W 4/14

(57) ABSTRACT

Disclosed is a method of facilitating communication of a message from a sender to a recipient based on geolocation. The method may include receiving, using a processor, a message associated with a sender. The message may be further associated with a topic indicator. Additionally, the method may include receiving, using a processor, a location criterion associated with the sender. Further, the method may include receiving, using a processor, each of an interest indicator and a location criterion associated with the recipient. Furthermore, the method may include transmitting, using a processor, the message to a recipient device associated with the recipient. The transmitting may be based on each of the topic indicator, the interest indicator associated with the recipient, the location criterion associated with the sender and the location criterion associated with the recipient. Additionally, the message may be configured for re-transmission by the recipient device.

### RELATED APPLICATIONS

Under the provisions of 35 U.S.C. §119(e), this application claims priority from provisional patent application No. 62/094,189, filed on Dec. 19, 2014 which is incorporated herein by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF THE INVENTION

Generally, the disclosure relates to communication systems. More specifically, the disclosure relates to methods, systems and devices for facilitating communication between recipients and senders based on geolocations.

### BACKGROUND

Currently, there is a wide range of communication tools that facilitate electronic communication of messages between users. Each communication tool may provide specific functionalities to meet particular user needs.

For instance, communication tools such as social networking tools enable users to form bidirectional relationships and subsequently exchange messages with each other. Accordingly, a user may be able to control which other users may communication with the user. As a result, the user may not be subjected to unwanted communications from other users who may not be part of the user's social network.

Further, some communication tools may enable users to filter communications directed to them based on predefined interests. Accordingly, users may not receive messages that may be irrelevant to their interests.

Furthermore, some communication tools enable users to receive communications that are associated with predefined locations. For example, a user may only receive communications such as promotional offers associated with stores physically located in the vicinity of the user's location. As a result, the communications may be more useful to the user due to proximity to the store.

However, there remains a need for improved methods and systems for facilitating communication between users based on geolocations of both a sender and a recipient.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Disclosed is a method of facilitating communication of a message from a sender to a recipient based on geolocation. The method may include receiving, using a processor, a message associated with a sender. The message may be further associated with a topic indicator. Additionally, the method may include receiving, using a processor, a location criterion associated with the sender. Further, the method may include receiving, using a processor, each of an interest indicator and a location criterion associated with the recipient. Furthermore, the method may include transmitting, using a processor, the message to a recipient device associated with the recipient. The transmitting may be based on each of the topic indicator, the interest indicator associated with the recipient, the location criterion associated with the sender and the location criterion associated with the recipient. Additionally, the message may be configured for re-transmission by the recipient device.

In some embodiments, the method may further include determining an interest match based on a comparison of the topic indicator with the interest indicator. In some embodiments, each of the topic indicator and the interest indicator may include a hashtag. Additionally, the method may include determining a location match based on a comparison of the location criterion associated with the sender with the location criterion associated with the recipient. Further, transmitting the message may be based on each of the interest match and the location match.

In some embodiments, one or more of the location criterion associated with the sender and the location criterion associated with the recipient may include a geographical region. Further, the geographical region may include one or more of a location associated with the sender and the location associated with the recipient.

In some embodiments, one or more of the location criterion associated with the sender and the location criterion associated with the recipient may include a reference location and a distance, wherein each of the reference location and the distance define a geographical region, wherein the geographical region comprises at least one of a location associated with the sender and the location associated with the recipient.

In some embodiments, the geographical region may be a circle. Further, the reference location may be the center of the circle and the distance may be the radius of the circle.

In some embodiments, the location associated with the sender may include a location of a sender device associated with the sender, wherein the location associated with the recipient may include a location of the recipient device.

In some embodiments, the method may further include determining, using a processor, each of the location of the recipient device and the location of the sender device.

In some embodiments, the message may be associated with a re-transmission parameter. Further, retransmission of the message by the recipient device may be based on the re-transmission parameter.

In some embodiments, the method may further include transmitting, using a processor, the re-transmission parameter to the recipient device.

In some embodiments, the re-transmission parameter may include a number of re-transmissions permitted.

In some embodiments, the re-transmission parameter may include a re-transmission counter. Further, the recipient device may be configured to perform re-transmission of the message based on a value of the re-transmission counter.

In some embodiments the method may further include decrementing the re-transmission counter. Further, the decrementing may be performed by the recipient device.

In some embodiments, the re-transmission parameter may include an indication of a re-transmission distance.

In some embodiments the method may further include transmitting, using a processor, the re-transmission parameter. Further, the transmitting may be performed by the recipient device.

Further disclosed is a method of facilitating communication between a sender device and a recipient device. Each step of the method may be performed by one or more processors. The method may include receiving a message from the sender device. Further, the method may include receiving a topic tag associated with the message. Furthermore, the method may include receiving each of a transmission location and a transmission distance. Further, each of the transmission location and the transmission distance may characterize a transmission region. Additionally, the method may include receiving an interest tag associated with the recipient device. Further, the method may include receiving each of a reception location and a reception distance. Furthermore, each of the reception location and the transmission distance may characterize a reception region. Additionally, the method may include determining an interest match based on a comparison of the topic tag with the interest tag. Further, the method may include, determining a location match based on an intersection of the transmission region and the reception region. Furthermore, the method may include transmitting the message to the recipient device based on each of the interest match and the location match. Additionally, the message may be configured for re-transmission by the recipient device.

In some embodiments, the transmission region may be a circular region characterized by a radius equal to the transmission distance. Similarly, the reception region may be a circular region characterized by a radius equal to the reception distance.

Further disclosed is a system for facilitating communication of a message from a sender to a recipient based on geolocation. The system may include each of a communication module and a processor. The processor may be configured to receive a message associated with a sender. The message may be further associated with a topic indicator. Further, the processor may be configured to receive a location criterion associated with the sender. Additionally, the processor may be configured to receive each of an interest indicator and a location criterion associated with the recipient. Furthermore, the communication module may be configured to transmit the message to a recipient device associated with the recipient. The transmission of the message may be based on each of the topic indicator, the interest indicator associated with the recipient, the location criterion associated with the sender and the location criterion associated with the recipient. Furthermore, the message may be configured for re-transmission by the recipient device.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure.

FIG. 2 illustrates communication of messages between senders and recipients based on geolocations in accordance with some embodiments.

FIG. 3 illustrates interaction of sender devices and recipient devices with a communication server in accordance with some embodiments.

FIG. 4 illustrates system logic components for facilitating communication between senders and recipients based on geolocations in accordance with some embodiments.

FIG. 5 illustrates a method of facilitating communication of a message from a sender to a recipient in accordance with some embodiments.

FIG. 6 illustrates a graphical user interface configured to facilitate communication between senders and recipients based on geolocations in accordance with some embodiments.

FIG. 7 illustrates geographical regions associated with senders and recipients in accordance with some embodiments.

FIG. 8 illustrates geographical regions associated with senders and recipients in accordance with some other embodiments.

FIG. 9 illustrates transmission regions and reception regions associated with senders and recipients in accordance with some other embodiments.

FIG. 10 is a block diagram of a system including a communication server for performing the method of FIG. 5.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of film production, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The disclosed methods and systems for facilitating communication may enable a user to access information pertinent to the user's current location in a simple and convenient way. Further, the system may allow a user to electronically share information with people who are in a defined radius of the user's location in a way that can be either real-time or date relevant.

The disclosed method and system may enable users to easily connect and communicate with others to share information electronically based upon their common geolocation or shared location radius. Users of the system may be able to send information including, among other things, corresponding latitude and longitude to the system. Other registered users who may be in a defined radius of the sender's latitude and longitude may receive the information electronically.

The system introduces a simple, electronic solution that, taking advantage of a user's current latitude and longitude, provides both the sender and a recipient the ability to easily connect with each other to share information relevant to their shared location or a defined radius of a specific location.

The system may include the following components:

1. User device to use the system such as Mobile Phone/Computer/Laptop

2. Software to implement the system.

3. Servers to deploy the system.

4. System Server Software Component.

5. System User Software Component.

Once a user is registered on the system, the user may be enabled to input a communication. The communication may include a latitude and longitude that can either be manually input or derived based upon the geolocation of a user device operated by the user. Based on the geolocation, the system may transmit the user's message to other registered users who may be within a defined radius of the geolocation.

A user may be able to connect to the system in multiple ways through a device such as mobile phone, computer, laptop, tablet and other electronic devices. After registering with the system, the user they may be able to communicate with other registered users by sending communications, receiving communications or both.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

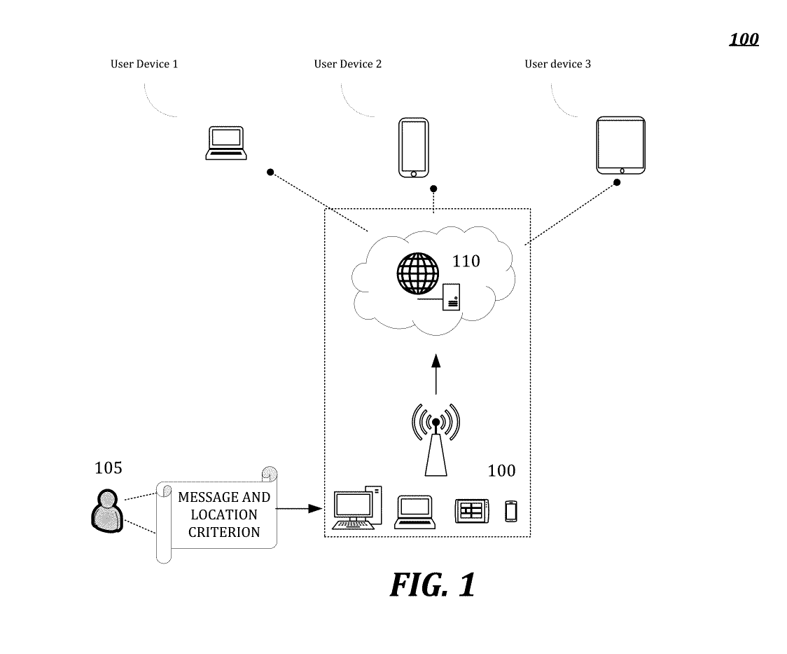

FIG. 1 illustrates one possible operating environment through which a platform consistent with embodiments of the present disclosure may be provided. The operating environment may comprise methods, systems, and devices collectively referred to as a platform. The platform may include a communication server 100 in communication with user devices such as user devices 1-3. The communication may be performed over a network 110. Although the present disclosure refers to various functions and operations performed by particular components of the platform (e.g., communication server or user devices), it should be understood that some platform components may be interchanged with others, and/or, where necessary, combined with other components to perform the functions and operations intended.

By way of non-limiting example, a communication platform 100 may be interconnected using a network 110. In some embodiments, network 110 may comprise a Local Area Network (LAN), a Bluetooth network, a Wi-Fi network and a cellular communication network. In other embodiments the communication platform may be hosted on a centralized server, such as, for example, a cloud computing service. A user 105 (e.g., a sender or a recipient) may access platform 100 through a software application. The software application may be embodied as, for example, but not be limited to, a website, a web application, a desktop application, and a mobile application compatible with the communication server 100. One possible embodiment of the software application may be provided by a communications management software executed on the communication platform 100 and remotely accessible using electronic devices such as laptop or tablet computers.

As will be detailed with reference to FIG. 1 below, the computing device through which the platform may be accessed may comprise, but not be limited to, for example, a desktop computer, laptop, a tablet, or mobile telecommunications device. Though the present disclosure is written with reference to a mobile telecommunications device, it should be understood that any computing device may be employed to provide the various embodiments disclosed herein.

The communication server 100 may be configured to communicate with each of user devices 1-3 over the network 110. Further, the communication server 100 may be configured to provide a user interface to the user 105. Accordingly, the user 105 may interact with the communication server in order to control communication of messages to the user devices 1-3. For example, the communication server 100 may display a GUI to the user 105 in order to provide each of the message, a sender location criterion and a topic indicator. Further, the communication server may also be configured to display a GUI to users associated with user devices 1-3 in order to receive each of a recipient location criterion and an interest indicator. Subsequently, the communication server 100 may compare the sender location criterion with the recipient location criterion to determine a location match. Similarly, the communication serve 100 may also be configured to compare the topic indicator with the interest indicator to determine an interest match. Accordingly, based on each of the location match and the interest match, the message may be delivered to user devices 1-3 over network 110. As a result, senders and recipients may communicate with each other. Further, the message may be configured to cause one or more of user devices 1-3 to re-transmit the message.

### III. PLATFORM OPERATION

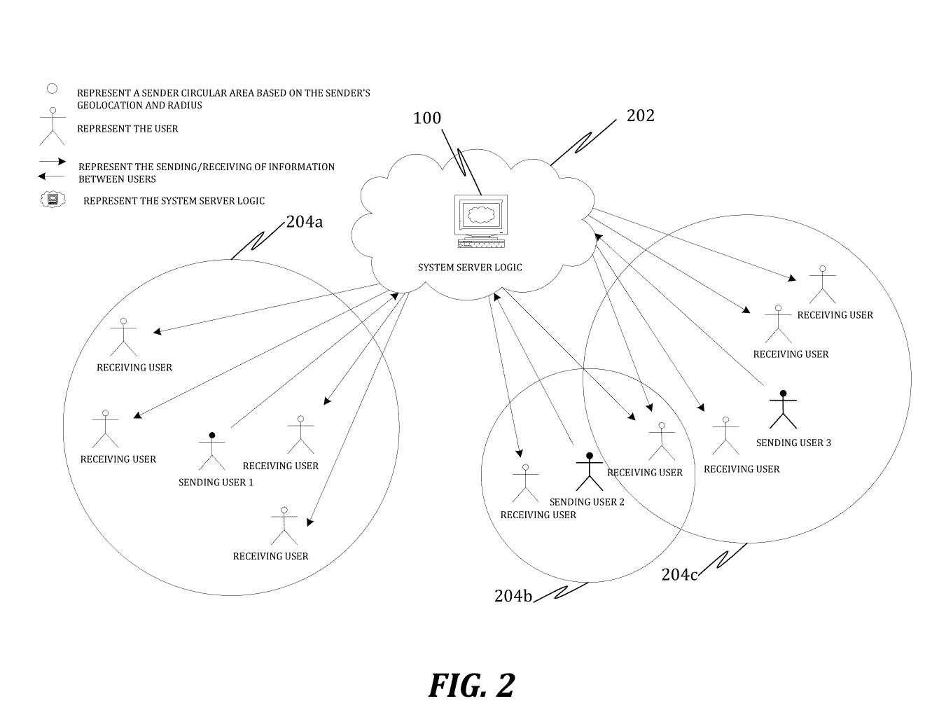

FIG. 2 illustrates a system 100 for facilitating communication between users based on geolocations according to some embodiments. The system may include a communication server 100 including one or more processors and a communication module. The communication module may be configured to communicate over a communication network 202 with one or more other electronic devices such as, user devices. In some embodiments, the communication network 202 may be similar to network 110 as described in conjunction with FIG. 1.

As illustrated, a user of the system 100 may include senders of messages, exemplarily depicted as Sending User 1-3 and recipients of the messages, exemplarily depicted as Recipient User 1-3.

Further, each sender of a message may provide a sender location criterion to the system 100. The sender location criterion in general indicates a geographical region 204 within which the message may be transmitted. In other words, the sender location criterion is a constraint provided by the sender that may limit the reception of the message to user devices located within the geographical region 204. In some instances, the sender location criterion may include each of a sender location and a distance. Accordingly, the geographical region may be a circle with center at the sender location and having a radius equal to the distance. For example, as exemplarily illustrated, the geographical region 204a may be characterized by the center being coincident with the location of Sending User 1 and having a radius equal to the distance specified by Sending User 1.

Further, each recipient may also provide a recipient location criterion to the system 100. The recipient location criterion in general indicates a geographical region 204 within which the message transmitted by a Sending User is designated for reception. For example, as depicted, Sending User 1 may designate the geographical region 204a for reception of the message transmitted by Sending User 1. Accordingly, if the recipient location criterion coincides with at least one location within the geographical region 204a, a recipient device associated with the recipient may receive the message. For example, Receiving Users depicted as situated within the geographical region 204a may be able to receive the message transmitted by the Sending User 1. However, Receiving Users situated in geographical regions 204b and 204c may not be able to receive the message transmitted by Sending User 1.

Furthermore, in some embodiments, the message transmitted by a Sending User such as Sending User 1 may be configured for re-transmission by one or more Receiving Users. For example, a re-transmission indicator may be included in the message by the system 100. Accordingly, a user device associated with a Receiving User situated within the geographical region 204a may be configured to process the message to identify re-transmission indicator. Subsequently, based on a value of the re-transmission indicator, the user device may be configured to perform re-transmission of the message. As a result, other Receiving Users who may not be situated within the geographical region 204a may be able to receive the message as long as such Receiving Users are within a predetermined distance from the user device performing the re-transmission. For example, a Receiving User situated within geographical region 204b but within a predetermined distance from the user device situated in geographical region 204a may receive the re-transmission of the message. Accordingly, the message may reach Receiving Users who may be situated outside the geographical region 204 corresponding to the original Sending User such as Sending User 1.

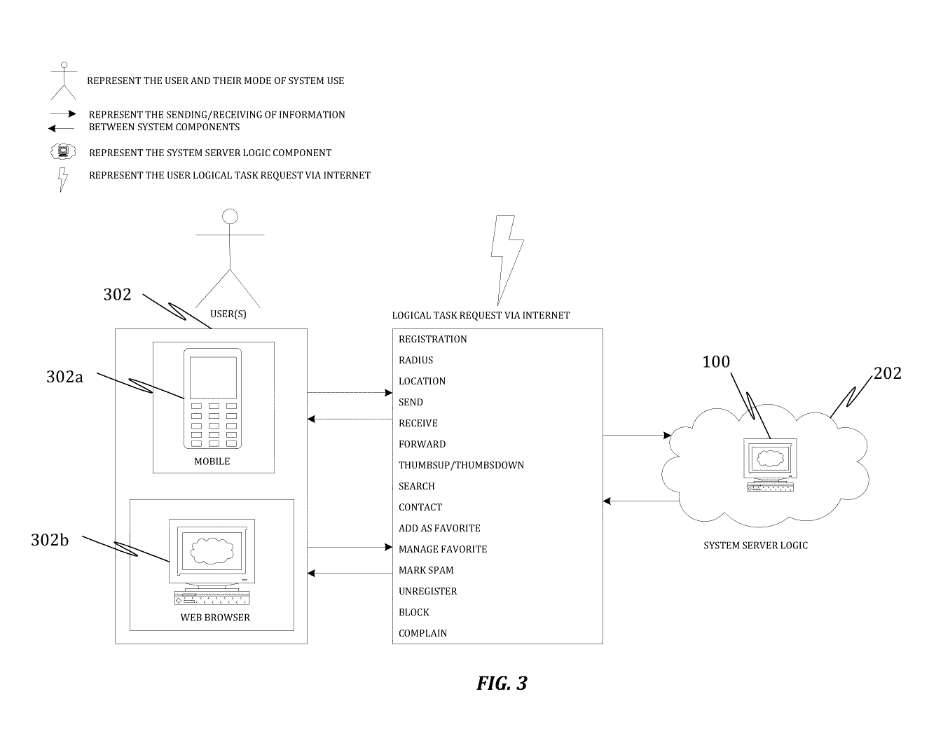

Turning now to FIG. 3, an illustration of the system 100 facilitating communication based on geolocation according to some other embodiments is shown. The system 100 may be configured to communicate with user devices 302 such as a mobile device 302a and a laptop computer 302b. Further, a user device 302 may be configured transmit one or more task requests to the system 100 through a communication network such as, for example, the internet.

Accordingly, the user device 302 may include a software application configured to enable the user device 302 to cooperate with the system 100 in order to facilitate communication. For instance, a communication app may be installed on the mobile phone 302a to facilitate cooperation with the system 100. Further, the communication app may present a Graphical User Interface (GUI) to a user operating the user device 302. The GUI may enable the user to provide one or more of the message to be transmitted, a sender location criterion, a topic indicator associated with the message and a logical task request. Alternatively, the GUI may be presented to the user through a browser application. As illustrated, user device 302b may include a browser application configured to transmit a URL to the system 100. In response, the system 100 may be configured to transmit a webpage including the GUI to the user device 302b which may then be displayed by the browser application.

Initially, a user may register with the system 100 by transmitting a Registration request to the system 100. Subsequently, the user may be presented with a GUI for receiving one or more of a message to be transmitted, a sender location criterion such as a location and a radius and one or more topic indicators such as, for example, hashtags. Accordingly, the user may be able to input the message and determine the extent of a geographical region where the message may be received. For instance, the location and radius specified by the user may define a circular geographical region with the center coinciding with the location and having the radius provided by the user.

Additionally, in some embodiments, the GUI may enable a user to receive one or more messages according to criteria provided by the user. For instance, the criteria may include each of a recipient location criterion such as a location and a radius and an interest tag. The location and the radius may define a circular geographical region such that message transmissions targeting at least one location within the circular geographical region may be received by the user.

Further, in some embodiments, the GUI may enable a user to forward a message received by the user from, for example, the system 100. In other words, the user may be enabled to perform re-transmission of a message to other users of the system 100.

Furthermore, in some embodiments, the GUI may enable a user to provide feedback on a message received from, for example, the system 100. The feedback may be in the form of one of a “Thumbs-up” and a “Thumbs-down”.

Additionally, in some embodiments, the GUI may enable a user to search for messages meeting a user specified criteria. For instance, the GUI may enable the user to specify one or more hashtags and provide a radius value such as 5 miles. Accordingly, the system 100 may be configured to search for messages which are targeted to any location within a circular geographical region centered on the user's current location and having a radius of 5 miles and also associated with the one or more hashtags. The system may further be configured to transmit the results of the search to the user device 302.

Further, in some embodiments, the GUI may enable a user to contact another user of the system 100 directly. For example, a message meeting criteria specified by a recipient may be displayed to the recipient along with a screen name and contact link of a sender of the message. The contact link may enable the recipient to contact the sender through the GUI. Alternatively, in some other embodiments, the contact link may enable the recipient to communicate with the sender through an external communication application such as, for example, email or Instant Messenger (IM).

Furthermore, in some embodiments, the GUI may enable a user to create favorites. For instance, an option of “Add to Favorites” may be associated with one or more of a sender, a recipient, a message, a topic indicator, an interest indicator, a location and a radius. For example, the GUI may enable a recipient to add the sender as a favorite. Similarly, the GUI may enable a recipient to select and mark multiple locations as favorites. Accordingly, messages targeted to geographical regions including at least one of the multiple locations may be received by the recipient. Additionally, in some embodiments, the GUI may enable the user to manage favorites. For instance, favorites may be displayed to the user along with an option to delete, edit or add a new favorite.

Further, in some embodiments, the GUI may enable the user to mark a message as spam. Such feedback from users may enable the system 100 to identify non-compliant users and take corrective actions to mitigate spamming. Similarly, in some embodiments, the GUI may enable a recipient to block a sender of a message. Accordingly, any further messages from the sender may not be delivered to the recipient.

Additionally, in some embodiments, the GUI may enable a user to complain against another user. Accordingly, behavior of users of the system 100 may be moderated and a socially acceptable environment may be created for users of the system 100. Moreover, in some embodiments, the GUI may enable a user to unregister from the system 100. Accordingly, the user may no longer receive messages from the system 100 or be able to send messages through the system 100.

In order to process the logical task requests transmitted by the user device 302, the system 100 may include a system server logic to perform one or more corresponding operations. Further, the system server logic may process the logical task requests according to configuration and preferences of a corresponding user. Additionally, each logical task request may be handled by the system server logic as single request.

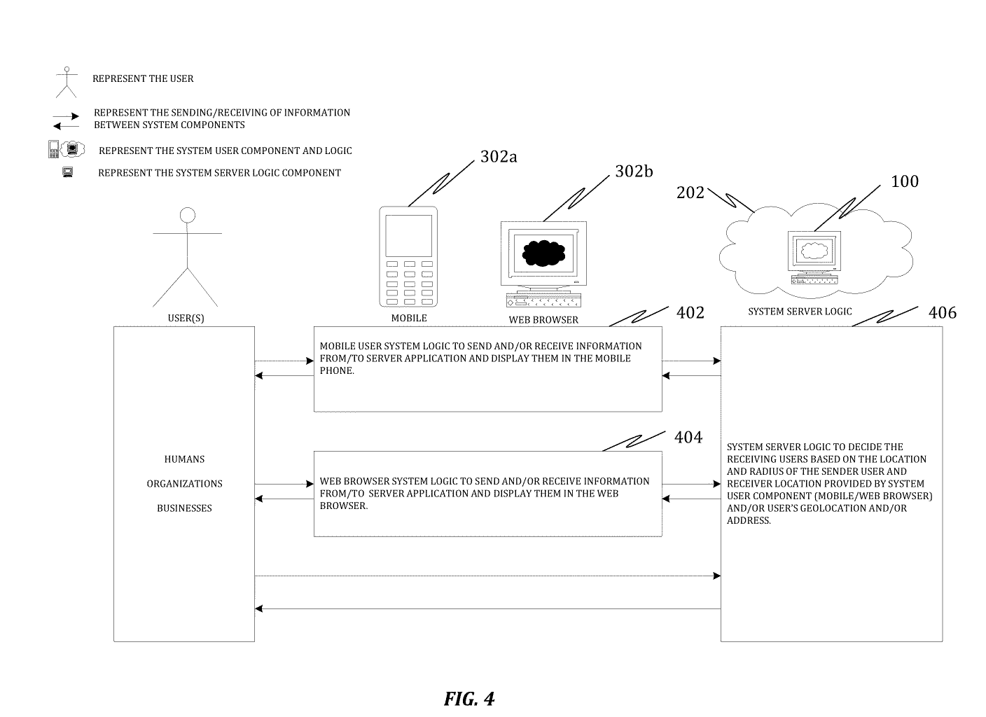

Moving on to FIG. 4, system logic components for facilitating communication based on geolocation according to some embodiments is illustrated. As depicted, the system 100 configured to facilitate communication based on geolocation may be in communication with one or more user devices 302 such as mobile phone 302a and laptop computer 302b. The user devices 302 may be associated with one or more users such as, for example, humans, organizations and businesses.

Further, each user device 302 may implement a user system logic configured to cooperate with the system 100. For instance, user system logic component 402 implemented in the mobile phone 302a may be configured to send information to an application server executable on the system 100 and/or receive information from the application server. Further, the user system logic component 402 may also be configured to display information received from the application server on a display device of the user device 302a. Similarly, user system logic component 404 implemented in the laptop computer 302b may be configured to send information to an application server executable on the system 100 and/or receive information from the application server. Further, the user system logic component 404 may also be configured to display information received from the application server on a display device of the user device 304b.

Furthermore, the system server logic component 406 may be implemented in the system 100. In some embodiments, the system server logic component 406 may be configured to identify recipients based on a sender location and radius provide by the sender and a recipient location criterion such as a location and radius provided by the recipient. As an example, the recipient location criterion may include the recipient's geolocation and/or address.

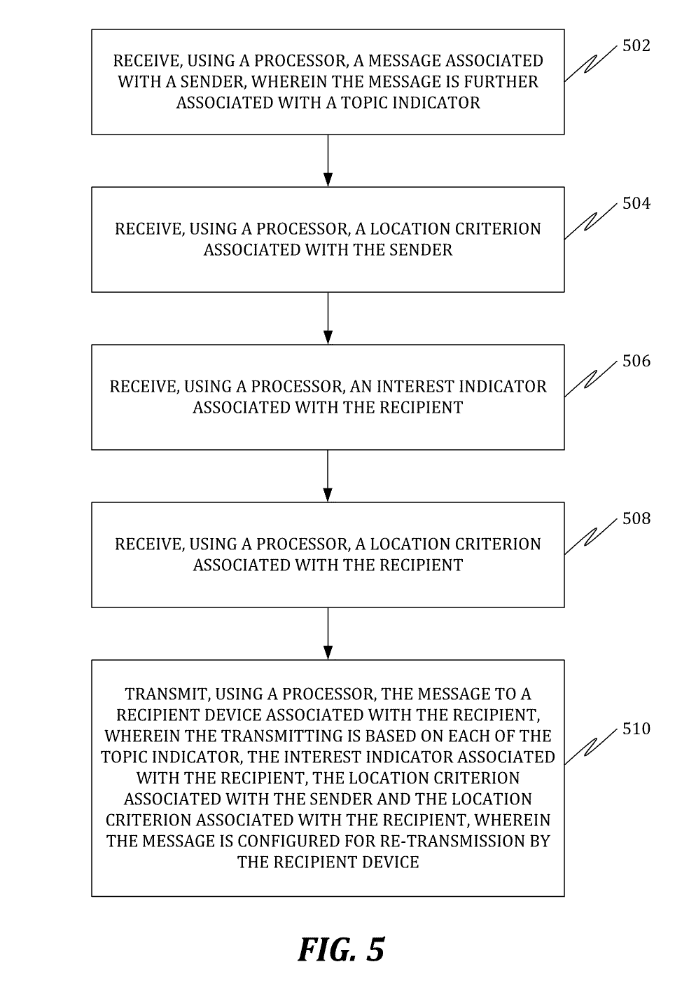

Turning now to FIG. 5, a method of facilitating communication from a sender to a recipient based on geolocation according to some embodiments is illustrated. Each of the sender and the recipient may include one or more of a human user, an organization, a business entity and a computer.

Further, the sender may be associated with one or more sender devices such as, for example, electronic devices capable of communicating over a communication network such as, for example, network 202. Accordingly, the one or more sender devices may include a communication module configured to communicate information over a communication network. Further, in some embodiments, the one or more sender devices may be operated by the sender. Examples of such electronic devices may include, but are not limited to, a mobile phone, a smartphone, a handheld computer, a laptop computer, a tablet computer and a desktop computer.

Similarly, the recipient may be associated with one or more recipient devices such as, for example, electronic devices capable of communicating over a communication network such as, for example, network 202. Accordingly, the one or more recipient devices may include a communication module configured to communicate information over a communication network. Further, in some embodiments, the one or more recipient devices may be operated by the recipient.

Further, in some embodiments, the method may be performed by the system 100 such as, for example, a communication server 100. Accordingly, the communication server 100 may be configured to communicate with each of the one or more sender devices and the one or more recipient devices in order to facilitate communication of the message.

Further, in order to facilitate cooperation with the communication server 100, each of the one or more sender devices and the one or more recipient devices may include a communication software. For instance, a sender device such as a smartphone may include a communication app that may be provided for download from an app store associated with the communication server 100. In another instance, a recipient device such as a laptop computer may include a browser application configured to execute the communication software provided by the communication server 100 through a web interface. For example, the communication software may be associated with a URL such as, for example, a website address. Accordingly, entering the website address into a URL bar of the browser application may result in at least a part of the communication software to be executed by the browser application.

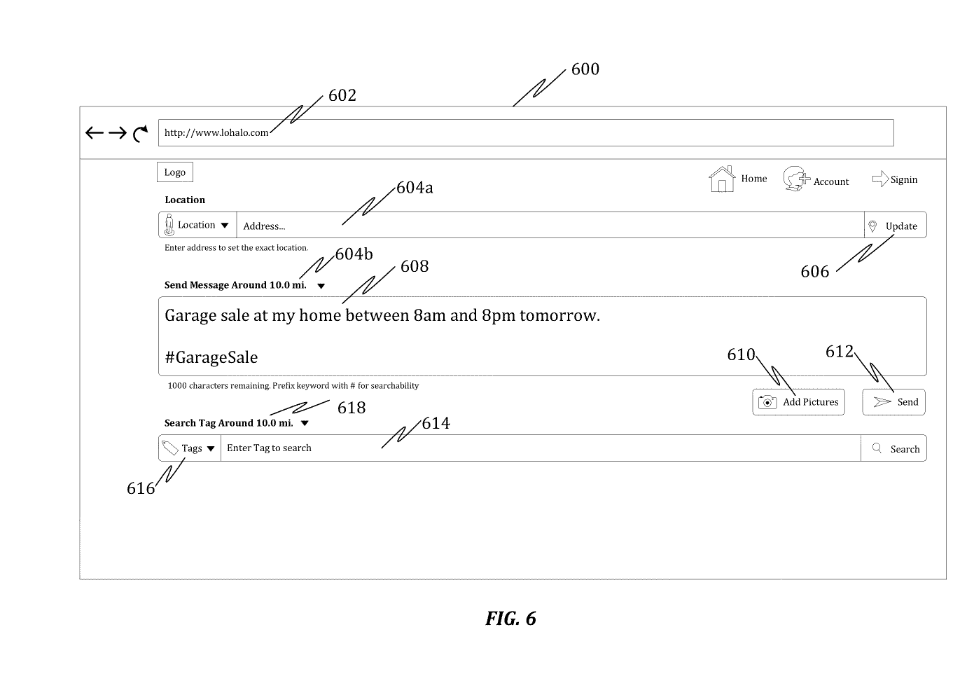

Further, the communication software executable on one or more of a sender device and a recipient device may present a user interface. The user interface may enable one or more of the sender and the recipient to use functionalities provided by the communication server 100. Further, the user interface may enable one or more of the sender and the recipient to control operation of the communication software configured to facilitate communication based on geolocation. An exemplary user interface 600 according to some embodiments is illustrated in FIG. 6.

In general, the user interface may be any means to receive inputs from a user. In some embodiments, the user interface may be a graphical user interface implemented using a display device and a processor. Further, in some embodiments, the user interface may be implemented using a touch-screen. Accordingly, users may conveniently provide inputs by physically interacting with the touch-screen using a finger or a stylus. Furthermore, in some embodiments, the user interface may include an input device such as, but not limited to, a keyboard, a mouse, a touch-pad, a stylus, a digital pen, a voice recognition device, a gesture recognition device and a gaze detection device.

In order to facilitate communication between the sender and the recipient, the method may include a step 502 of receiving, using a processor, a message associated with the sender. In some embodiments, the message may include one or more of a text, a picture, a video, an audio and a multimedia. Further, in some embodiments, a form of the message transmitted to the recipient device may be at least one of a Short Messaging Service (SMS) message, an email and a push notification.

In some embodiments, the message associated with the sender may be provided by the sender. For example, the sender may operate a sender device to provide the message through a user interface of the sender device. For example, a GUI element 608 as illustrated in FIG. 6 may be configured to accept the message from the sender. Accordingly, the message may be received by the communication server 100 through a communication network such as, network 202. Further, GUI element 610 may be provided to enable the sender to attach one or more images as part of the message. Additionally, the GUI element 612 may be provided to enable the sender to send the message.

In some embodiments, the message associated with the sender may be previously stored at the communication server 100. Examples of such messages may include, but are not limited to, a seasons greeting or a sale announcement. Further, a message indicator may be associated with the message. Accordingly, the sender may initiate sending of the message by providing the message indicator to the communication server 100. For example, the user interface of the communication software may present a list of message indicators to the sender. Further, the sender may be enabled to select the message indicator. Accordingly, the message indicator may be transmitted from the sender device to the communication server 100. Subsequently, the message may be retrieved from a storage device included in the communication server 100 based on the message indicator.

In some embodiments, the message may be further associated with a topic indicator. In general, the topic indicator may be any information that indicates a semantic content of the message. Further, a form of the topic indicator may be one or more of a text, a picture, a video, an audio and a multimedia.

In some embodiments, the topic indicator may indicate a subject or topic corresponding to the message. For example, the topic indicator corresponding to a message such as “Garage sale at my home between 8 am and 8 pm tomorrow.” may include “Garage Sale”. In some embodiments, the topic indicator may include one or more keywords or tags. Further, in some other embodiments, the topic indicator may include one or more hashtags. A hashtag may be a word or phrase preceded by a hash sign (#). In some instances, the hashtag may not contain the space character. For example, as illustrated in FIG. 6, the hashtag may be “#GarageSale”.

In some embodiments, the topic indicator may be automatically determined, using a processor, based on an analysis of the message. For example, in case the message is of textual form, text analysis, such as, for example, Natural Language Processing (NLP) based text analysis, may be used to detect the topic indicator. As another example, in case the message of an audio form, speech recognition may be used to convert the message to textual form and subsequently perform text analysis to detect the topic indicator. As yet another example, in case the message includes an image, image analysis such as, for example, object recognition may be used to identify the topic indicator.

In some embodiments, the topic indicator may be provided by the sender. Accordingly, the method may further include receiving, using a processor, the topic indicator from a sender device associated with the sender. For instance, the communication software may present a user interface, such as user interface 600, to the sender to enable the sender to input the topic indicator.

In some embodiments, the user interface may include a text box configured to receive textual input from the sender. For instance, GUI element 608 may be configured to receive the topic indicator in the form of a hashtag. Since a hashtag begins with a hash sign (#), the communication server may be able to process input entered in the GUI element 608 and separate the message from the topic indicator in the form of a hashtag. In some other embodiments, the user interface may include a drop down menu of pre-determined topic indicators including the topic indicator. Accordingly, the sender may be enabled to select the topic indicator from the drop down menu.

In some embodiments, the topic indicator may be stored at one or more of a user device, such as the sender device or a recipient device and the communication server 100. For instance, the communication server 100 may include a database configured to store each of the message and the topic indicator. Further, in some embodiments, the topic indicator may be stored separately from the message. However, the topic indicator may be logically linked to the message. Additionally, in some other embodiments, the topic indicator may be inserted into the message. For example, the topic indicator may be inserted into a header portion of the message.

In some embodiments, the topic indicator may enable improved management of the message. For instance, the topic identifier may be used to identify the message among a plurality of messages. As an example, the topic indicator may enable users to search for the message in a database based on the topic indicator. Further, the topic indicator enables the sender to direct the message to recipients who may have an interest in content associated with the topic indicator. Accordingly, the topic indicator enables senders to direct messages to targeted recipients. Similarly, the topic indicator also enables recipients to receive messages that may be of interest to them. As a result, the topic indicator may function as a filter to enables the sender to select a set of recipients among a plurality of recipients to receive the message. Likewise, the topic indicator may function as a filter to enable a recipient to select the message from a plurality of messages.

Further, in addition to the topic indicator, locations may also be used for improved management of the message. In some embodiments, the locations may include geolocations associated with one or more of the sender, a sender device associated with the sender, a recipient, a recipient device associated with the recipient and the communication server 100. Accordingly, in some embodiments, the method may further include determining, using a processor, each of the location of the recipient device and the location of the sender device. Furthermore, in some embodiments each of the recipient device and the sender device may include a positioning unit such as, for example, a Global Positioning System (GPS) receiver, configured to determine locations. Accordingly, in some embodiments, the locations may be represented in terms of latitude and longitude. Alternatively, the location associated with one or more of the sender and the recipient may include for example, a postal address.

In order to take the locations into account to facilitate communication, the method may further include a step 504 of receiving, using a processor, a location criterion associated with the sender. In general, the location criterion associated with the sender may be a location constraint that defines a spatial region within which reception of the message may be limited. In other words, the location criterion associated with the sender may define a transmission region corresponding to the message such that user devices configured to receive messages associated with at least one location within the transmission region may be able to receive the message. In an instance, a recipient device located within the transmission region may be able to receive the message transmitted by the sender. In another instance, a recipient device located outside the transmission region may still be able to receive the message as long as the recipient device is configured to receive messages associated with a location situated within the transmission region.

In some embodiments, the location criterion associated with the sender may be provided by the sender. Accordingly, the method may further include receiving, using a processor, the location criterion associated with the sender from a sender device associated with the sender.

For instance, the user interface may include a GUI element 604 configured to receive the location criterion associated with the sender. For example, the GUI element 604a may be configured to receive a location associated with the sender. Further, GUI element 604b may be configured to receive a distance associated with the sender. For example, GUI element 604b may be a slider that may enable the sender to specify a distance from a predetermined range of distances such as, for example, 0.1 to 10 miles. Further, in some embodiments, the location criterion associated with the sender may include a default reference location and a default radius. For example, the default reference location may be the address of the sender and the default radius value may be 10 miles. Moreover, a GUI element 606 may be provided to enable the sender to update the location to the current location of the sender device associated with the sender.

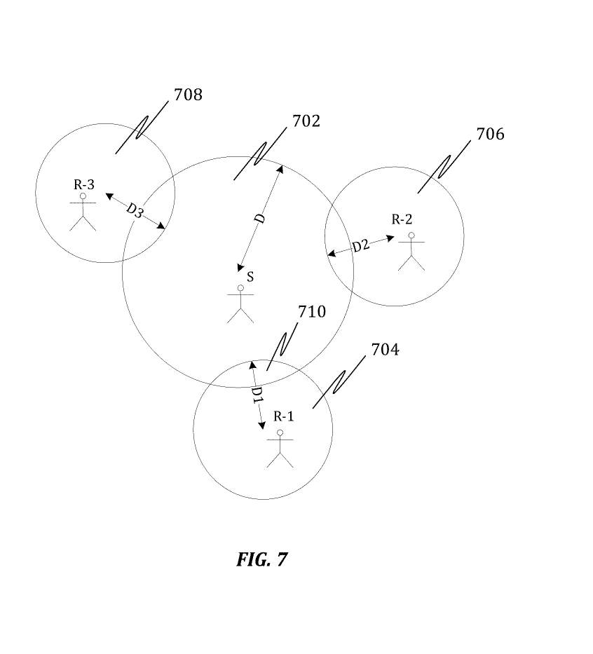

Accordingly, based on each of the location associated with the sender and the distance, a geographical region, such as a circular region may be defined having center coincident with the location and a radius equal to the distance. For instance, as illustrated in FIG. 7, the location criterion associated with the sender, such as sender S may include a circular geographical region 702 with a center coincident with a location of a sender device of the sender S. Further, the area of the circular geographical region 702 may be based on a distance “D” provided, for example, by the sender.

In general, the location criterion associated with the sender may include a geographical region of any shape and size. Further, the geographical region may include one or more of a location associated with the sender and a location associated with the recipient. For example, the geographical region may include one or more of a location of a sender device associated with the sender, a location of a recipient device associated with the recipient, a location of the sender, a location of the recipient and the location of the communication server 100.

In some embodiments, the location criterion associated with the sender may include a reference location and a distance. Further, each of the reference location and the distance may define a geographical region. Furthermore, the geographical region may include one or more of a location associated with the sender and a location associated with the recipient. In some embodiments, the location associated with the sender may include a location of a sender device associated with the sender. Similarly, the location associated with the recipient may include a location of the recipient device.

In some embodiments, the geographical region may include one or more of a location of a sender device associated with the sender, a location of a recipient device associated with the recipient, a location of the sender, a location of the recipient and the location of the communication server 100. Further, in some embodiments, the geographical region may be a circle. Further, the reference location may be the center of the circle and the distance may be the radius of the circle.

Thus, each of the topic indicator and the location criterion associated with the message may provide a filtering criteria for targeting the message to a set of recipients who may be interested to receive the message.

Accordingly, in order to deliver the message to relevant recipients, the method may include a step 506 of receiving, using a processor, an interest indicator associated with the recipient.

The interest indicator may be provided by the recipient through a recipient device. Accordingly, in some embodiments, the method may further include receiving, using a processor, the interest indicator from the recipient device associated with the recipient. For instance, the user interface 600 may be configured to present a GUI element 614, such as a text box for receiving the interest indicator in the form of, for example, hashtags. Further, a GUI element 616 may also be provided to enable the recipient to select one or more hashtags from a drop down menu.

Further, the method may include a step 508 of receiving, using a processor, a location criterion associated with the recipient. Furthermore, in some embodiments, the location criterion associated with the recipient may be provided by the recipient through a recipient device. Accordingly, in some embodiments, the method may further include receiving, using a processor, the location criterion associated with the recipient from the recipient device associated with the recipient.

For instance, the user interface may include a GUI element 618 configured to receive the location criterion associated with the recipient. For example, the GUI element 618 may be configured to receive a distance associated with the recipient. For example, GUI element 618 may be a slider that may enable the recipient to specify a distance from a predetermined range of distances such as, for example, 0.1 to 10 miles. Further, in some embodiments, the location criterion associated with the recipient may include a default reference location and a default radius. For example, the default reference location may be the address of the recipient and the default radius value may be 10 miles.

In general, the location criterion associated with the recipient may include a geographical region of any shape and size. Further, the geographical region may include one or more of a location associated with the sender and a location associated with the recipient. For example, the geographical region may include one or more of a location of a sender device associated with the sender, a location of a recipient device associated with the recipient, a location of the sender, a location of the recipient and the location of the communication server 100.

In some embodiments, the location criterion associated with the recipient may include a reference location and a distance. Further, each of the reference location and the distance may define a geographical region. Furthermore, the geographical region may include one or more of a location associated with the recipient and a location associated with the sender. In some embodiments, the location associated with the recipient may include a location of a recipient device associated with the recipient. Similarly, the location associated with the sender may include a location of the sender device.

In some embodiments, the geographical region may include one or more of a location of a sender device associated with the sender, a location of a recipient device associated with the recipient, a location of the sender, a location of the recipient and the location of the communication server 100. Further, in some embodiments, the geographical region may be a circle. Further, the reference location may be the center of the circle and the distance may be the radius of the circle.

In some embodiments, the location criterion associated with the recipient may include a plurality of reference locations and a distance. Further, each of a reference location of the plurality of reference locations and the distance define a geographical region. Furthermore, the geographical region may include at least one of a location associated with the sender and the location associated with the recipient.

For example, as illustrated in FIG. 7, the location criterion associated with the recipient such as recipient R-1 may define a circular geographical region 704 having a center co-incident with a location of the recipient R-1 and having a radius equal to distance “D1” provided the recipient R-1. Similarly, the location criterion associated with recipient R-2 may define a circular geographical region 706 having a center co-incident with a location of the recipient R-2 and having a radius equal to distance “D2” provided the recipient R-2. Likewise, the location criterion associated with recipient R-3 may define a circular geographical region 708 having a center co-incident with a location of the recipient R-3 and having a radius equal to distance “D3” provided the recipient R-3.

In general, the geographical region defined by the location criterion associated with the recipient may include one or more locations associated with the message. In other words, by specifying the location criterion, the recipient may be defining a filtering criteria to select the message having an association with a location situated within the geographical region. Additionally, the filtering criteria may also include the interest indicator.

Furthermore, the method may include a step 510 of transmitting, using a processor, the message to a recipient device associated with the recipient. The transmitting may be based on each of the topic indicator, the interest indicator associated with the recipient, the location criterion associated with the sender and the location criterion associated with the recipient. In other words, the recipient may be identified as relevant for transmitting the message based on each of the topic indicator, the interest indicator associated with the recipient, the location criterion associated with the sender and the location criterion associated with the recipient.

Further, in some embodiments, in order to determine the recipient relevant to the message, the method may further include determining, using a processor, an interest match based on a comparison of the topic indicator with the interest indicator. For example, the hashtag provided by the sender may be compared with the hashtag provide by the recipient. If the hashtags are identical or similar, an interest match may be determined.

Additionally, the method may include determining, using a processor, a location match based on a comparison of the location criterion associated with the sender with the location criterion associated with the recipient. For example, referring to FIG. 7, a location match may be determined based on an overlap of geographical region associated with the sender and a geographical region associated with the recipient. For instance, an overlapping region 710 may exist between geographical region 702 of sender S and geographical 704 of recipient R-1.

Further, in some embodiments, transmitting the message may be based on each of the location match and the interest match. As a result, recipient R-1 may be able to receive the message on a recipient device associated with recipient R-1 provided that the interest indicator specified by recipient R-1 matches with topic indicator specified by Sender S.

In some embodiments, the method may further include identifying, using a processor, the message based on a comparison of the interest indicator and the topic indicator. Moreover, in some embodiments, the identifying may include searching a database configured to store the message. Further, the searching may be performed periodically. For example, a recipient may provide the interest indicator in the form of one or more hashtags. Subsequently, the communication server 100 may periodically search a database for messages associated with the topic indicator in the form of the hashtags.

In some embodiments, the method may further include determining, using a processor, the interest indicator based on user interactions associated with the recipient. For example, user interactions with the communication software may be monitored to identify one or more hashtags specified by the recipient in the past. Subsequently, when the recipient accesses the user interface of the communication software, the one or more hashtags may be suggested to the recipient.

Additionally, in some embodiments, the message may be configured for re-transmission by the recipient device. In some embodiments, the message may be associated with a re-transmission parameter. Further, retransmission of the message by the recipient device may be based on the re-transmission parameter. The re-transmission parameter may be included in the message by one or more of the sender of the message, the communication server 100 and a recipient of the message.

In an instance, a header portion of the message may include the re-transmission parameter. Accordingly, a recipient device may be configured to extract the retransmission parameter from the header portion and perform re-transmission accordingly.

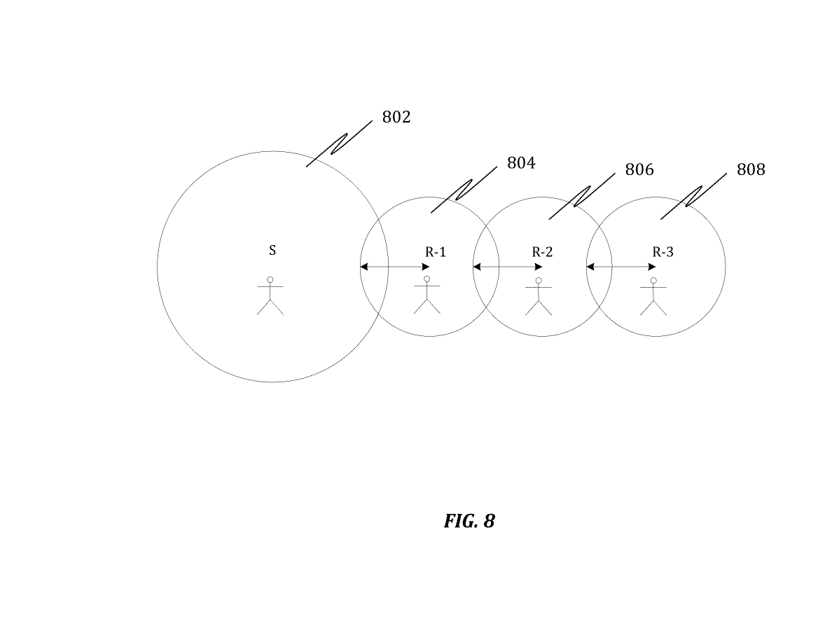

For example, referring to FIG. 8, the sender may transmit the message that may be associated with the geographical region 802 in the form of a circle. Further, each of recipient R-1, R-2 and R-3 may have specified corresponding location criterion defining geographical regions 804, 806 and 808 respectively. However, only geographical region 804 may overlap with geographical region 802 associated with the sender. Accordingly, user R-1 may be able to receive the message transmitted by the sender S. Further, based on presence of the re-transmission parameter in the message, the recipient device associated with R-1 may be configured to perform re-transmission of the message.

In some embodiments, the re-transmission of the message may be performed by the recipient device of R-1 re-transmitting the message to the communication server 100. In addition, the recipient R-1 may indicate a geographical region corresponding to the re-transmission. For instance, as illustrated in FIG. 8, the geographical region corresponding to the re-transmission by R-1 may be identical to the geographical region defined by the location criterion associated with recipient R-1 for reception of the message.

However, in some embodiments, the geographical region for reception of a message may be different from the geographical region for performing re-transmission of the message. In general, a geographical region corresponding to re-transmission of the message may be of a different shape and size compared to the geographical region corresponding to reception of the message.

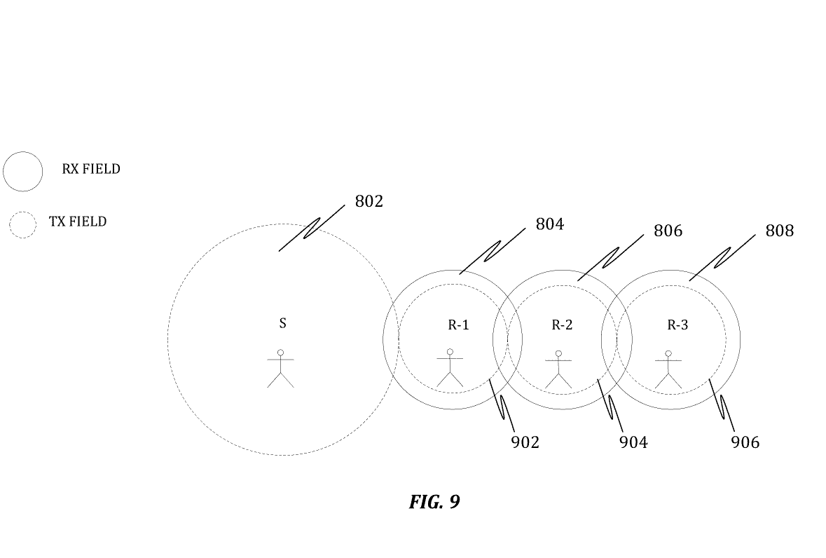

For instance, referring to FIG. 9, the geographical region 902 corresponding to re-transmission of the message may be smaller in size compared to the geographical region 804 designated for reception of the message. Similarly, each of geographical regions 904 and 906 corresponding to re-transmission may be smaller than the geographical regions 806 and 808 respectively. However, in other embodiments, the geographical region 902 may be greater than geographical region 804.

In some embodiments, the re-transmission distance may be specified by the original sender of the message. For instance, the re-transmission distance for re-transmission may be included in the re-transmission parameter. Alternatively, the re-transmission distance may be specified by the recipient of the recipient device, such as R-1.

Further, upon receiving the re-transmitted message, the communication server 100 may transmit the message to other recipient devices associated with a location that falls within the re-transmission distance from the location of the recipient device. For example, recipient R-2 may have indicated location criterion for receiving messages associated with geographical region 806. Further, since geographical region 806 overlaps with geographical region 804, the communication server 100 may be configured to transmit the message to a recipient device of R-2.

In some embodiments, the method may further include transmitting, using a processor, the re-transmission parameter to the recipient device. Accordingly, multiple re-transmissions of the message may be achieved. For example, subsequently to receiving the message, the recipient device of R-2 may perform re-transmission of the message. Accordingly, the recipient device of recipient R-3 may be enabled to receive the message.

In some embodiments, the re-transmission parameter may include a number of re-transmissions permitted. For instance, the sender of the message may specify the number of re-transmissions. Accordingly, a recipient device configured to receive the message may perform re-transmission of the message based on the number of rep-transmissions.

Further, in some embodiments, in order to manage the number of re-transmissions, the re-transmission parameter may include a re-transmission counter. Further, the recipient device may be configured to perform re-transmission of the message based on a value of the re-transmission counter. Moreover, in some embodiments, the method may further include decrementing the re-transmission counter. Further, the decrementing may be performed by the recipient device subsequent to performing the re-transmission.

Further disclosed is a method of facilitating communication between a sender device and a recipient device. Each step of the method may be performed by one or more processors. The method may include receiving a message from the sender device. Further, the method may include receiving a topic tag associated with the message. Furthermore, the method may include receiving each of a transmission location and a transmission distance. Further, each of the transmission location and the transmission distance may characterize a transmission region. Additionally, the method may include receiving an interest tag associated with the recipient device. Further, the method may include receiving each of a reception location and a reception distance. Furthermore, each of the reception location and the transmission distance may characterize a reception region. Additionally, the method may include determining an interest match based on a comparison of the topic tag with the interest tag. Further, the method may include, determining a location match based on an intersection of the transmission region and the reception region. Furthermore, the method may include transmitting the message to the recipient device based on each of the interest match and the location match. Additionally, the message may be configured for re-transmission by the recipient device.

In some embodiments, the transmission region may be a circular region characterized by a radius equal to the transmission distance. Similarly, the reception region may be a circular region characterized by a radius equal to the reception distance.

Further disclosed is a system, such as the system 100, for facilitating communication of a message from a sender to a recipient based on geolocation. The system may include each of a communication module and a processor. The processor may be configured to receive a message associated with a sender. The message may be further associated with a topic indicator. Further, the processor may be configured to receive a location criterion associated with the sender. Additionally, the processor may be configured to receive each of an interest indicator and a location criterion associated with the recipient. Furthermore, the communication module may be configured to transmit the message to a recipient device associated with the recipient. The transmission of the message may be based on each of the topic indicator, the interest indicator associated with the recipient, the location criterion associated with the sender and the location criterion associated with the recipient. Furthermore, the message may be configured for re-transmission by the recipient device.

While various embodiments of the disclosed methods and systems have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

### IV. COMMUNICATION SERVER ARCHITECTURE

Platform 100 may be embodied as, for example, but not be limited to, a website, a web application, a desktop application, and a mobile application compatible with a computing device. The communication server may comprise, but not be limited to, a desktop computer, laptop, a tablet, or mobile telecommunications device. Moreover, the platform 100 may be hosted on a centralized server, such as, for example, a cloud computing service. Although the method of FIG. 5 has been described to be performed by the communication server 100, it should be understood that, in some embodiments, different operations may be performed by different networked elements in operative communication with the communication server 100.

Embodiments of the present disclosure may comprise a system having a memory storage and a processing unit. The processing unit coupled to the memory storage, wherein the processing unit is configured to perform the stages of the method of FIG. 5.

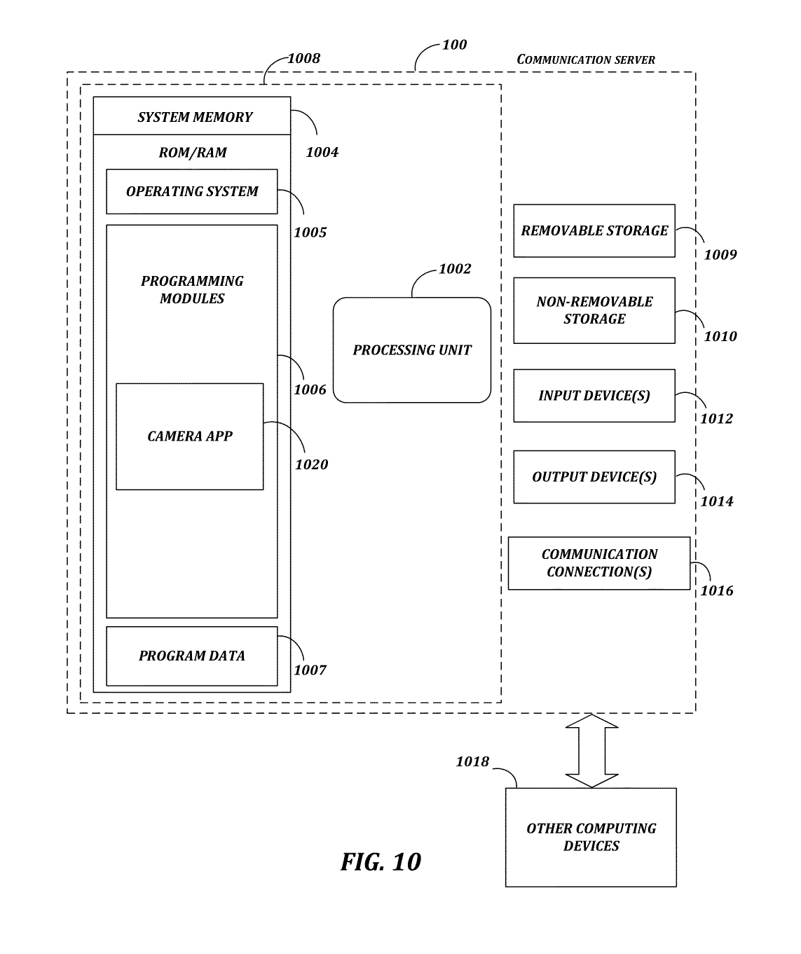

FIG. 10 is a block diagram of a system including communication server 100. Consistent with various embodiments of the disclosure, the aforementioned memory storage and processing unit may be implemented in a computing device, such as communication server 100 of FIG. 1. Any suitable combination of hardware, software, or firmware may be used to implement the memory storage and processing unit. For example, the memory storage and processing unit may be implemented with communication server 100 or any of other computing devices 1018, in combination with communication server 100. The aforementioned system, device, and processors are examples and other systems, devices, and processors may comprise the aforementioned memory storage and processing unit, consistent with embodiments of the disclosure.

With reference to FIG. 10, a system consistent with various embodiments of the disclosure may include a computing device, such as communication server 100. In a basic configuration, communication server 100 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling communication server 100's operation. In one embodiment, programming modules 1006 may include a workflow management software 1020. Furthermore, embodiments of the disclosure may be practiced in conjunction with a graphics library, other operating systems, or any other application program and is not limited to any particular application or system. This basic configuration is illustrated in FIG. 10 by those components within a dashed line 1008.

Routing server 100 may have additional features or functionality. For example, communication server 100 may also include additional data storage devices (removable and/or non-removable) such as, for example, magnetic disks, optical disks, or tape. Such additional storage is illustrated in FIG. 10 by a removable storage 1009 and a non-removable storage 1010. Computer storage media may include volatile and nonvolatile, removable and non-removable media implemented in any method or technology for storage of information, such as computer readable instructions, data structures, program modules, or other data. System memory 1004, removable storage 1009, and non-removable storage 1010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the communication server 100. Any such computer storage media may be part of the communication server 100. Routing server 100 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

Routing server 100 may also contain a communication connection 1016 that may allow communication server 100 to communicate with other computing devices 1018, such as over a network in a distributed computing environment, for example, an intranet or the Internet. Communication connection 1016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1004, including operating system 1005. While executing on processing unit 1002, programming modules 1006 (e.g., communication software 1020) may perform processes including, for example, one or more stages of the method of FIG. 5 as described above. The aforementioned process is an example, and processing unit 1002 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method of facilitating communication of a message from a sender to a recipient based on geolocation, the method comprising:
receiving, using a processor, a message associated with a sender, wherein the message is further associated with a topic indicator;
receiving, using a processor, a location criterion associated with the sender;
receiving, using a processor, an interest indicator associated with the recipient;
receiving, using a processor, a location criterion associated with the recipient; and
transmitting, using a processor, the message to a recipient device associated with the recipient, wherein the transmitting is based on each of the topic indicator, the interest indicator associated with the recipient, the location criterion associated with the sender and the location criterion associated with the recipient, wherein the message is configured for re-transmission by the recipient device.

2. The method of claim 1 further comprising receiving, using a processor, the topic indicator from a sender device associated with the sender.

3. The method of claim 1 further comprising receiving, using a processor, the interest indicator from a recipient device associated with the recipient.

4. The method of claim 1 further comprising receiving, using a processor, the location criterion associated with the sender from a sender device associated with the sender.

5. The method of claim 1 further comprising receiving, using a processor, the location criterion associated with the recipient from a recipient device associated with the recipient.

6. The method of claim 1 further comprising:
determining an interest match based on a comparison of the topic indicator with the interest indicator; and
determining a location match based on a comparison of the location criterion associated with the sender with the location criterion associated with the recipient, wherein transmitting the message is based on each of the interest match and the location match.

7. The method of claim 1, wherein at least one of the location criterion associated with the sender and the location criterion associated with the recipient comprises a geographical region, wherein the geographical region comprises at least one of a location associated with the sender and the location associated with the recipient.

8. The method of claim 1, wherein at least one of the location criterion associated with the sender and the location criterion associated with the recipient comprises a reference location and a distance, wherein each of the reference location and the distance define a geographical region, wherein the geographical region comprises at least one of a location associated with the sender and the location associated with the recipient.

9. The method of claim 8, wherein the geographical region is a circle, wherein the reference location is the center of the circle, wherein the distance is the radius of the circle.

10. The method of claim 8, wherein the location associated with the sender comprises a location of a sender device associated with the sender, wherein the location associated with the recipient comprises a location of the recipient device.

11. The method of claim 1 further comprising determining, using a processor, each of the location of the recipient device and the location of the sender device.

12. The method of claim 1, wherein the message is associated with a re-transmission parameter, wherein retransmission of the message by the recipient device is based on the re-transmission parameter.

13. The method of claim 1 further comprising transmitting, using a processor, the re-transmission parameter to the recipient device.

14. The method of claim 12, wherein the re-transmission parameter comprises a number of re-transmissions permitted.

15. The method of claim 14, wherein the re-transmission parameter comprises a re-transmission counter, wherein the recipient device is configured to perform re-transmission of the message based on a value of the re-transmission counter.

16. The method of claim 15 further comprising decrementing the re-transmission counter, wherein the decrementing is performed by the recipient device.

17. The method of claim 11, wherein the re-transmission parameter comprises an indication of a re-transmission distance.

18. The method of claim 13 further comprising transmitting, using a processor, the re-transmission parameter, wherein the transmitting is performed by the recipient device.

19. The method of claim 1, wherein each of the topic indicator and the interest indicator comprises a hashtag.

20. The method of claim 1 further comprising:
receiving, using a processor, the interest indicator from a recipient device associated with the recipient; and
identifying, using a processor, the message based on a comparison of the interest indicator and the topic indicator.

21. The method of claim 20, wherein the identifying comprises searching a database configured to store the message, wherein the searching is performed periodically.

22. The method of claim 1 further comprising determining, using a processor, the interest indicator based on user interactions associated with the recipient.

23. The method of claim 1 further comprising determining, using a processor, the topic indicator based on an analysis of the message.

24. The method of claim 1, wherein the message comprises at least one of text, image, video and audio.

25. The method of claim 1, wherein a form of the message transmitted to the recipient device is at least one of a Short Messaging Service (SMS) message, an email and a push notification.

26. The method of claim 1, wherein each of the location criterion associated with the sender and the location criterion associated with the recipient comprises a default reference location and a default radius.

27. The method of claim 1, wherein the location criterion associated with the recipient comprises a plurality of reference locations and a distance, wherein each of a reference location of the plurality of reference locations and the distance define a geographical region, wherein the geographical region comprises at least one of a location associated with the sender and the location associated with the recipient.

28. A method of facilitating communication between a sender device and a recipient device, wherein each step of the method is performed by at least one processor, the method comprising:
receiving a message from the sender device;
receiving a topic tag associated with the message;
receiving each of a transmission location and a transmission distance, wherein each of the transmission location and the transmission distance characterize a transmission region;
receiving an interest tag associated with the recipient device;
receiving each of a reception location and a reception distance, wherein each of the reception location and the transmission distance characterize a reception region; and
determining an interest match based on a comparison of the topic tag with the interest tag;
determining a location match based on an intersection of the transmission region and the reception region; and
transmitting the message to the recipient device based on each of the interest match and the location match, wherein the message is configured for re-transmission by the recipient device.

29. The method of claim 28, wherein the transmission region is a circular region characterized by a radius equal to the transmission distance, wherein the reception region is a circular region characterized by a radius equal to the reception distance.

30. A system for facilitating communication of a message from a sender to a recipient based on geolocation, the system comprising each of a communication module and a processor, wherein the communication module is configured to:
receive a message associated with a sender, wherein the message is further associated with a topic indicator;
receive a location criterion associated with the sender;
receive an interest indicator associated with the recipient;
receive a location criterion associated with the recipient; and
transmit the message to a recipient device associated with the recipient, wherein the transmission is based on each of the topic indicator, the interest indicator associated with the recipient, the location criterion associated with the sender and the location criterion associated with the recipient, wherein the message is configured for re-transmission by the recipient device.
